(19) United States
(12) Patent Application Publication
(10) Pub. No.: US 2025/0170009 A1
(43) Pub. Date: May 29, 2025

(54) LIGHTWEIGHT HUMAN BODY ASSISTANCE DEVICE BASED ON SINGLE DRIVE ACTUATOR

(71) Applicant: HYPERSHELL CO., LTD., Shanghai (CN)

(72) Inventors: Kuan SUN, Shanghai (CN); Yingjie QIAO, Shanghai (CN)

(21) Appl. No.: 19/036,838

(22) Filed: Jan. 24, 2025

Related U.S. Application Data
(63) Continuation-in-part of application No. PCT/CN2023/108891, filed on Jul. 24, 2023.
(63) Continuation-in-part of application No. PCT/CN2023/091431, filed on Apr. 28, 2023.

(30) Foreign Application Priority Data
Jul. 25, 2022 (CN) 202210888010.8
Nov. 24, 2022 (CN) 202211496045.3

(51) Int. Cl. A61H 3/00; A61H 1/02

(52) U.S. Cl. CPC A61H 3/00; A61H 1/0244; A61H 2003/007; A61H 2201/0192; A61H 2201/149

(57) ABSTRACT

A lightweight human body assistance device based on a single actuator, includes a drive actuator, and a first drive rod and a second drive rod respectively set on two sides of the drive actuator. The drive actuator includes a stator housing and a rotor shaft rotatable relative to the stator housing. The first drive rod rotates with the stator housing, and the second drive rod rotates with the rotor shaft. One side of the first drive rod is connected to a first drive back end that matches a leg on one side of the human body, and one side of the second drive rod is connected to a second drive back end that matches a leg on other side of the human body.

This application is a continuation in part application of international application No. PCT/CN2023/108891 and international application PCT/CN2023/091431 and claims priority to Chinese Patent Application No. 202210888010.8, filed on Jul. 25, 2022 and Chinese Patent Application No. 202211496045.3 filed on Nov. 24, 2022, and the disclosures of which are incorporated herein by reference in their entireties.

### TECHNICAL FIELD

The present disclosure relates to the field of human body exoskeleton walking assistance, and particularly relates to a lightweight human body assistance device based on a single drive actuator.

### BACKGROUND

Existing assistance devices for a lower part of a human body are generally mounted on hips or a waist. In terms of power, a drive motor or a hydraulic drive is mainly adopted. In the design of the drive motor, drive devices are set on two sides of human thighs to drive left and right legs to move alternately. In a solution of hydraulic drive, a hydraulic actuator is mostly fixed to a back in a backpack form.

For example, an application with an application number No. CN202010364008.1 and entitled “Assistance Walking and Auxiliary Support Mechanism” includes a left leg, a right leg, feet, a waist-wearing module, and an auxiliary support telescopic rod, and a foot is mounted on each of the left leg and the right leg. Each of the left leg and the right leg includes a hip joint connector, a thigh support rod, a thigh rope drive mechanism, a knee joint connector, a lower leg support rod, a lower leg rope drive mechanism, an ankle joint connector, and a shock absorption module. The hip joint connector is connected to the waist-wearing module; and the thigh support rod and the hip joint connector are rotatably connected relative to each other.

Lower-limb assistance exoskeletons manufactured with the above existing technologies mainly have the following shortcomings.

1. Multiple drive motors increase overall weight and power consumption of the assistance exoskeleton, and thus a user needs to carry a power source with a larger capacity, which further increases the overall weight and power consumption. This is very environmentally unfriendly and fails to balance the endurance and the lightweight wearing experience.

2. Multiple drive motors make it more difficult to control an entire assistance exoskeleton system, thereby increasing instability of the system.

3. Equipment using hydraulic/pneumatic drives is heavier than equipment using the drive motor, and mass of the equipment itself adds significant burden to the user's waist and back. Advantages of assistance are only evident under heavy loads.

4. Hydraulic or pneumatic artificial muscles are exposed to natural environment and are prone to rust and malfunction.

Therefore, assistance exoskeletons designed using an existing multi-motor drive solution or the hydraulic/pneumatic drive solution is bulky. It is difficult for a single person to wear the assistance exoskeletons independently, and hard to store the assistance exoskeletons when not worn.

### SUMMARY

The present disclosure discloses a lightweight human body assistance device based on a single drive actuator, including a rigid support, a drive actuator, a left drive mechanism, and a right drive mechanism; wherein
the left drive mechanism includes a left rotatable base and a left drive rod that swings relative to the left rotatable base, and the left rotatable base is fixed on a left side of the rigid support;
the right drive mechanism includes a right rotatable base and a right drive rod that swings relative to the right rotatable base, and the right rotatable base is fixed on a right side of the rigid support; and
the drive actuator includes a left transmission cable connected to the left drive rod, a right transmission cable connected to the right drive rod, an auxiliary transmission cable connecting the left drive rod and the right drive rod, and a drive mechanism that drives the left transmission cable and the right transmission cable; and
wherein the drive mechanism pulls the left transmission cable to drive the left drive rod to swing relative to the left rotatable base; during the swinging of the left drive rod, the auxiliary transmission cable drives the right drive rod to swing in an opposite direction to the left drive rod; and
the drive mechanism pulls the right transmission cable to drive the right drive rod to swing relative to the right rotatable base; and during the swinging of the right drive rod, the auxiliary transmission cable drives the left drive rod to swing in an opposite direction to the right drive rod.

Further, the left transmission cable and the auxiliary transmission cable are arranged on two sides of a connection point of the left drive rod in the swing direction of the left drive rod; and
the right transmission cable and the auxiliary transmission cable are arranged on two sides of a connection point of the right drive rod in the swing direction of the right drive rod.

Further, the drive mechanism includes a ball screw, a sliding platform that moves reciprocally along the ball screw, and a driver that drives the ball screw to rotate; and
wherein a left side of the sliding platform is connected to the left transmission cable and a right side of the sliding platform is connected to the right transmission cable.

Further, the left rotatable base and the right rotatable base are fixed to the hips by an elastic strap wrapped around the human body.

Further, the left rotatable base and the right rotatable base are swingable relative to the elastic strap.

Further, each of the left rotatable base and the right rotatable base is connected to the elastic strap by a swivel ball joint.

Further, each of the left drive rod and the right drive rod is fixedly connected to a thigh by a flexible strap.

Further, a torque output end of the drive actuator is connected to the left drive mechanism to transmit torque to the left drive mechanism, and a body of the drive actuator is fixed on the right drive mechanism to transmit a counteracting force received by the left drive mechanism when driving a left leg of the human body to the right drive mechanism and the counteracting force serves as power for the right drive mechanism to drive a right leg of the human body.

The present disclosure discloses a lightweight human body assistance device based on a single drive actuator, including a drive actuator, and a first drive rod and a second drive rod respectively set on two sides of the drive actuator,
the drive actuator comprises a stator housing and a rotor shaft rotatable relative to the stator housing;
the first drive rod rotates with the stator housing, and the second drive rod rotates with the rotor shaft;
one side of the first drive rod is connected to a first drive back end that matches a leg on one side of the human body, and one side of the second drive rod is connected to a second drive back end that matches a leg on other side of the human body; and
when the drive actuator is in operation, the stator housing and the rotor shaft rotate reciprocally within a certain angle such that the first drive rod and the second drive rod are driven to drive legs on both sides to move reciprocally relative to each other.

Further, a front end of the first drive rod is connected to the stator housing, and a back end of the first drive rod is connected to the first drive back end that fits the leg on one side of the human body; and

a front end of the second drive rod is connected to the rotor shaft, and a back end the second drive rod is connected to the second drive back end that fits the leg on the other side of the human body.

Further, a fixing joint is connected to each of the first drive rod and the second drive rod, the fixing joint is connected to the human body and provides support and fixation for the drive actuator, the first drive rod and the second drive rod, and each of the first drive rod and the second drive rod rotates around a corresponding fixing joint.

Further, the fixing joint is fixed around a hip joint of the human body.

Further, the assistance device further includes a waist belt that matches the human body; wherein the fixing joint is fixed around the hip joint of the human body through the waist belt.

Further, the first drive rod comprises a first rotating arm and a first curved rod; and the second drive rod comprises a second rotating arm and a second curved rod;
a front end of the first rotating arm is connected to the stator housing, and a back end of the first curved rod is equipped with the first drive back end that is connected to and matches the leg on one side of the human body; and
a front end of the second rotating arm is connected to the rotor shaft, and a back end of the second curved rod is equipped with the second drive back end that is connected to and matches the leg on the other side of the human body.

Further, the first rotating arm and the first curved rod are hinged; and the second rotating arm and the second curved rod are hinged.

Further, there is a certain range of relative displacement space between the first curved rod and the first drive back end; and
there is a certain range of relative displacement space between the second curved rod and the second drive back end.

Further, a connecting block is arranged between the first curved rod and the first drive back end, the first curved rod is connected to one side of the connecting block through a spherical linkage, and the first drive back end is slidably connected to other side of the connecting block; and
a connecting block is arranged between the second curved rod and the second drive back end, the second curved rod is connected to one side of the connecting block through a spherical linkage, and the second drive back end is slidably connected to other side of the connecting block;
the first drive back end and the second drive back end are arc-shaped plates that match the legs of the human body; and
the arc-shaped plates are located in front of or behind the legs of the human body.

Further, the drive actuator is horizontally positioned at a back or front of waist and abdomen of the human body; and
the first drive rod and the second drive rod are rigidly connected to the two sides of the drive actuator, respectively; and the drive actuator is suspended around the human body when in use.

Further, an angle between the first drive rod and the stator housing is adjustable, and an angle between the second drive rod and the rotor shaft is adjustable.

Further, the stator housing is set inside a sleeve, one side of the sleeve is provided with an opening that allows the stator housing to move reciprocally relative to the sleeve, and a depth of the stator housing in the sleeve is adjustable; and
the first drive rod is connected to the stator housing through the sleeve, and an angle between the first drive rod and the stator housing is adjustable.

The present disclosure has the following beneficial effects compared to the prior art.

1. A single drive actuator is used to control the left and right legs, the force applied by the drive actuator and the counteracting force received by the drive actuator are directly applied to both legs, which solves the problem of the counteracting force being applied to the waist and hips in existing devices. Compared with the existing dual-drive, one drive actuator is saved according to the present disclosure. Thus, the cost, power consumption, and weight are reduced, and the overall assistance performance is improved. Also, it is extremely convenient to control the human body assistance device.

2. The left drive rod and the right drive rod are interconnected by an auxiliary transmission cable. When one drive rod swings, the other drive rod can be driven to swing in the opposite direction.

Under this effect, when the driver drives the sliding platform to slide to the right, the sliding platform during sliding pulls the left transmission cable to drive the left drive rod to swing. At this time, the driver applies force to the left drive rod through the left transmission cable.

Regarding the counteracting force, the left drive rod transmits the counteracting force to the right drive rod through the auxiliary transmission cable, achieving the technical effect of directly applying the force applied by the drive actuator and the counteracting force received by the drive actuator to both legs.

3. The rotatable bases of the drive mechanism are rigidly connected to the drive actuator, and the drive actuator is suspended on one side of the human body. The assistance force generated by the drive rods which rotate relative to the rotatable bases is directly applied to both legs, such that both legs separate and merge, independent of the hips. Therefore, the hips only need to bear part of the weight of the assistance device, which can avoid the situation where there is local effort-saving but overall effort-consuming.

### BRIEF DESCRIPTION OF DRAWINGS

FIG. 1 is a front view of an assistance device according to the present disclosure;

FIG. 2 is a rear view of the assistance device according to the present disclosure;

FIG. 3 is a basic structural diagram of an assistance device according to the present disclosure;

FIG. 4 is a schematic diagram of a drive actuator, a left drive mechanism and a right drive mechanism according to the present disclosure;

FIG. 5 is a force analysis diagram of a human body during walking;

FIG. 6 is an overall structural diagram of the present disclosure;

FIG. 7 is a top view of FIG. 6;

FIG. 8 is a specific structural diagram of a drive actuator in the present disclosure;

FIG. 9 is a specific structural diagram of a first drive rod in the present disclosure;

FIG. 10 is a specific structural diagram of a second drive rod in the present disclosure;

FIG. 11 is a usage state diagram of the present disclosure;

FIG. 12 is a structural diagram of a connection between a first curved rod and a first drive back end in the present disclosure;

FIG. 13 is a schematic diagram showing the adjustment of a waist size by adjusting an angle between the drive actuator and each of the drive rods set on two sides of the drive actuator;

FIG. 14 is a schematic diagram showing the adjustment of the waist size by adjusting a depth of the stator housing inserted into the sleeve;

FIG. 15 is a schematic diagram showing a state where a right foot is on the ground and a left foot is lifted in an embodiment of the present disclosure; and

FIG. 16 is a schematic diagram showing a state where the left foot is on the ground and the right foot is lifted in an embodiment of the present disclosure.

### DETAILED DESCRIPTION

To make the objectives, technical solutions, and advantages of the present disclosure clearer, the technical solutions in the present disclosure will be described more clearly and completely below with reference to the drawings in the embodiments of the present disclosure.

### Embodiment 1

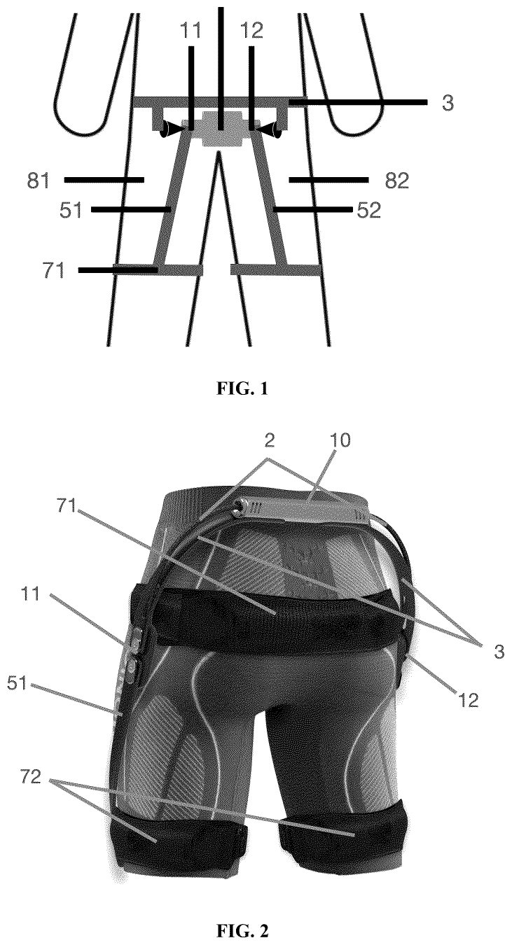

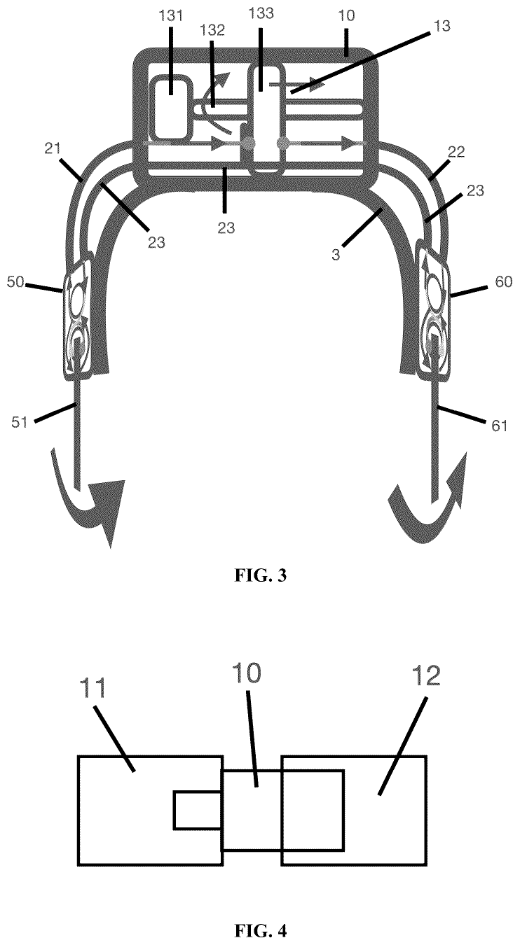

As shown in FIGS. 1 to 4, the present disclosure discloses a lightweight human body assistance device based on a single drive actuator, which includes a rigid support 3, a drive actuator 10, a left drive mechanism 11 and a right drive mechanism 12.

The left drive mechanism 11 is configured for driving a left leg 81 of the human body, the left drive mechanism 11 includes a left rotatable base 50 and a left drive rod 51 that swings relative to the left rotatable base 50, and the left rotatable base 50 is fixed on a left side of the rigid support 3.

The right drive mechanism 12 is configured for driving a right leg 82 of the human body, the right drive mechanism 12 includes a right rotatable base 60 and a right drive rod 61 that swings relative to the right rotatable base 60, and the right rotatable base 60 is fixed on a right side of the rigid support 3.

The drive actuator 10 is fixed on the rigid support 3 and is configured for transmitting power to the left drive mechanism 11 and the right drive mechanism 12. The drive actuator 10 includes a left transmission cable 21 connected to the left drive rod 51, a right transmission cable 22 connected to the right drive rod 61, an auxiliary transmission cable 23 connecting the left drive rod 51 and the right drive rod 61, and a drive mechanism 13 that drives the left transmission cable 21 and the right transmission cable 22.

The left transmission cable 21 and the auxiliary transmission cable 23 are arranged on two sides of a connection point of the left drive rod 51 in the swing direction of the left drive rod 51.

The right transmission cable 22 and the auxiliary transmission cable 23 are arranged on two sides of a connection point of the right drive rod 61 in the swing direction of the right drive rod 61.

The drive mechanism 13 pulls the left transmission cable 21 to drive the left drive rod 51 to swing relative to the left rotatable base 50; and during the swinging of the left drive rod 51, the auxiliary transmission cable 23 drives the right drive rod 61 to swing in an opposite direction to the left drive rod 51.

The drive mechanism 13 pulls the right transmission cable 22 to drive the right drive rod 61 to swing relative to the right rotatable base 60; and during the swinging of the right drive rod 61, the auxiliary transmission cable 23 drives the left drive rod 51 to swing in an opposite direction to the right drive rod 61.

The drive actuator 10 transmits torque to the left drive mechanism 11 and transmits a counteracting force received by the left drive mechanism 11 when driving the left leg of the human body to the right drive mechanism 12 and the counteracting force serves as power for the right drive mechanism 12 to drive the right leg of the human body.

A torque output end of the drive actuator 10 is connected to the left drive mechanism 11 to transmit torque to the left drive mechanism 11, and a body of the drive actuator 10 is fixed on the right drive mechanism 12 to transmit the counteracting force received by the left drive mechanism 11 when driving the left leg of the human body to the right drive mechanism 12 and the counteracting force serves as power for the right drive mechanism 12 to drive the right leg of the human body.

The drive mechanism 13 includes a ball screw 132, a sliding platform 133 that moves reciprocally along the ball screw 132, and a driver 131 that drives the ball screw 132 to rotate.

The left side of the sliding platform 133 is connected to the left transmission cable 21, and the right side of the sliding platform 133 is connected to the right transmission cable 22.

The left rotatable base 50 and the right rotatable base 60 are fixed to the hips by an elastic strap 71 wrapped around the human body. Each of the left rotatable base 50 and the right rotatable base 60 is connected to the elastic strap 71 through a swivel ball joint, and each of the left rotatable base 50 and the right rotatable base 60 is rotatable relative to the elastic strap 71, such that the human body can squat freely after wearing the device. That is, in the squatting process, the elastic strap 71 keeps stationary relative to the human body, and the each of the left rotatable base 50 and the right rotatable base 60 rotates relative to the elastic strap 71.

The left drive rod 51 and the right drive rod 61 are fixedly connected to thighs by a flexible strap 72.

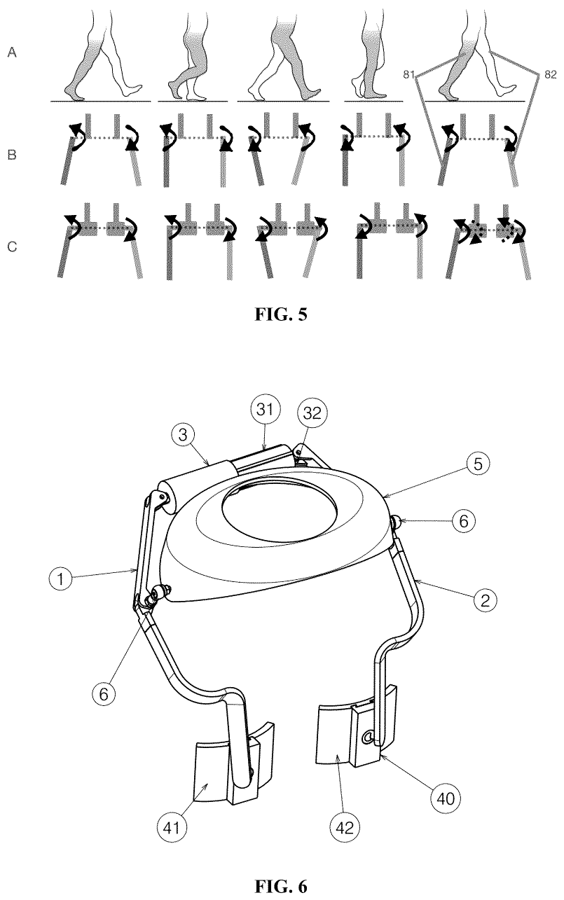

As shown in FIG. 5A and FIG. 5B, during normal walking, the human body can walk by applying rotating torque to the left leg 81 and the right leg 82 through muscle contraction and relaxation.

As shown in FIG. 5C, traditional exoskeletons achieve assistance by two drive controllers mounted on both sides.

Specifically, in an existing device as shown in FIG. 5C, a power output mechanism that provides rotating force by gears, shaft transmission or the like is fixed to the back or waist, and the leg drive rod connected to the thigh rotates around the power output mechanism so as to realize walking. The leg drive rod applies rotating torque to the human leg to achieve walking, but a counteracting torque will be applied on the power output mechanism, which is then applied to the back or waist.

Compared to the prior art, the present disclosure uses a single drive controller to drive the left drive mechanism and the right drive mechanism. The left drive rod and the right drive rod are interconnected by an auxiliary transmission cable 23, and when one drive rod swings, it can drive the other drive rod to swing in the opposite direction.

Under this effect, when the driver 131 drives the sliding platform to slide to the right, the sliding platform which is sliding pulls the left transmission cable to drive the left drive rod 51 to swing. At this time, the driver 131 applies force to the left drive rod 51 through the left transmission cable 21.

Regarding the counteracting force, the left drive rod 51 transmits the counteracting force to the right drive rod 61 by the auxiliary transmission cable 23, achieving a technical effect of directly applying the force applied by the drive actuator and the counteracting force received by the drive actuator to both legs.

### Embodiment 2

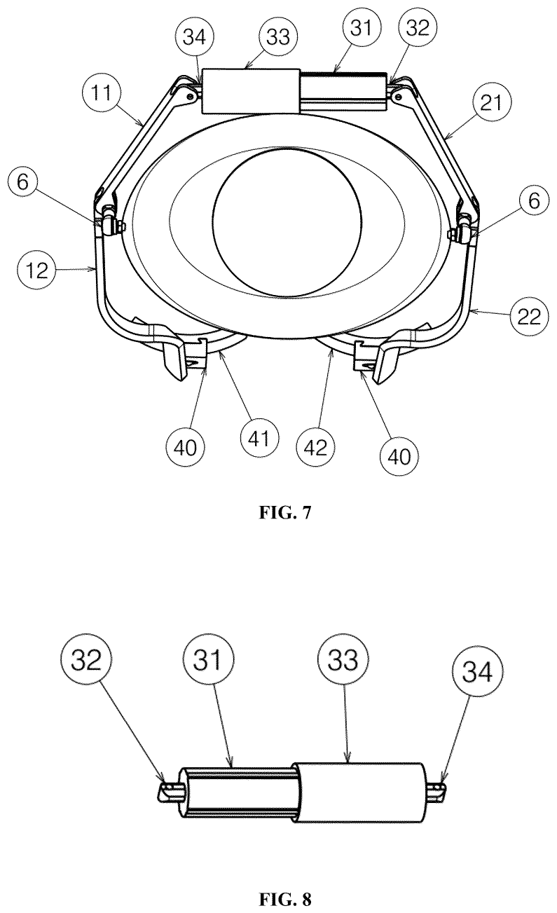

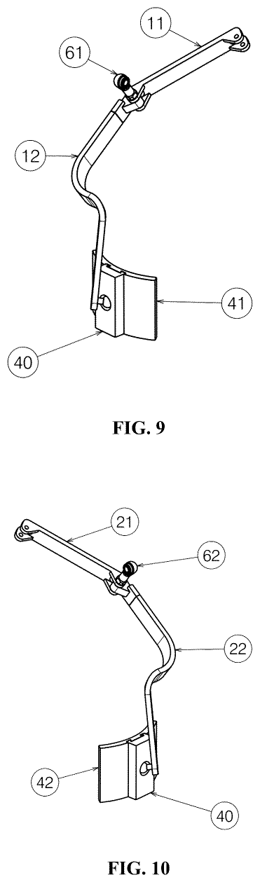

As shown in FIGS. 6 to 14, the present disclosure discloses another lightweight human body assistance device based on a single drive actuator, which includes a drive actuator 3, a first drive rod 1 and a second drive rod 2 respectively set on two sides of the drive actuator 3. The drive actuator 3 includes a stator housing 31 and a rotor shaft 32 rotatable relative to the stator housing 31.

A front end of the first drive rod 1 is connected to the stator housing 31, and a back end of the first drive rod 1 is connected to a first drive back end 41 that fits a leg on one side of a human body; and a front end of the second drive rod 2 is connected to the rotor shaft 32, and a back end of the second drive rod 2 is connected to a second drive back end 42 that fits a leg on the other side of the human body.

The first drive rod 1 includes a first rotating arm 11 and a first curved rod 12, and the second drive rod 2 includes a second rotating arm 21 and a second curved rod 22.

The front end of the first rotating arm 11 is connected to the stator housing 31, and a back end of the first curved rod 12 is equipped with the first drive back end 41 that is connected to and matches the leg on one side of a human body.

The front end of the second rotating arm 21 is connected to the rotor shaft 32, and the back end of the second curved rod 22 is equipped with the second drive back end 42 that is connected to and matches the leg on one side of a human body.

The first rotating arm 11 and the first curved rod 12 are hinged, and the second rotating arm 21 and the second curved rod 22 are hinged. There is a certain range of relative displacement space between the first curved rod 12 and the first drive back end 41, and there is a certain range of relative displacement space between the second curved rod 22 and the second drive back end 42.

A connecting block 40 is arranged between the first curved rod 12 and the first drive back end 41, the first curved rod 12 is connected to one side of the connecting block 40 through a spherical linkage, and the first drive back end 41 is slidably connected to the other side of the connecting block 40.

Another connecting block 40 is arranged between the second curved rod 22 and the second drive back end 42, the second curved rod 22 is connected to one side of the connecting block 40 through a spherical linkage, and the second drive back end 42 is slidably connected to the other side of the connecting block 40.

When the drive actuator 3 is in operation, the stator housing 31 and the rotor shaft 32 rotate reciprocally within a certain angle, the first drive rod 1 rotates with the stator housing 31, and the second drive rod 2 rotates with the rotor shaft 32 so as to drive the legs on both sides of the human body to move reciprocally relative to each other.

A fixing joint 6 is connected to each of the first drive rod 1 and the second drive rod 2. The fixing joint 6 is fixed around the hip joint of the human body through a waist belt 5 and provide support and fixation for the walking exoskeleton. Each of the first drive rod 1 and the second drive rod 2 rotates around a corresponding fixing joint 6.

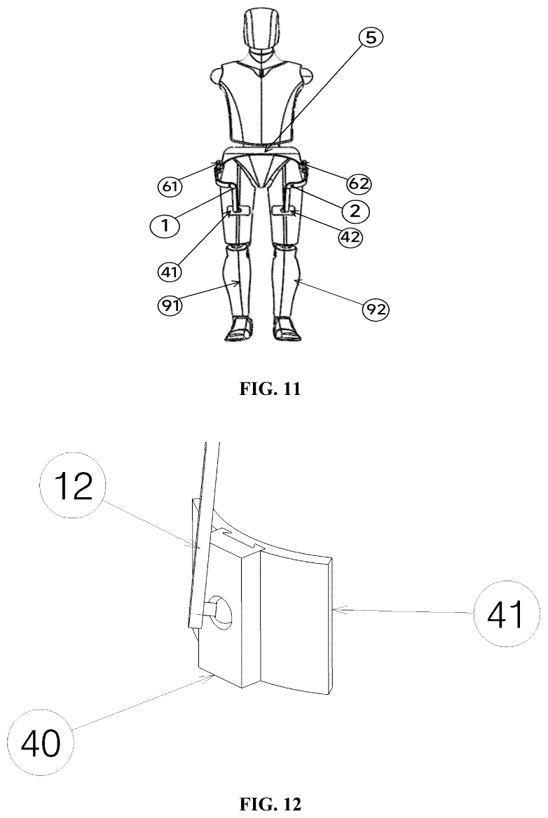

The first drive back end 41 and the second drive back end 42 are arc-shaped plates that match the legs of the human body. As shown in FIG. 11, in this embodiment, the arc-shaped plates are located in front of the legs, and the drive actuator 3 is horizontally positioned at the back of the waist and abdomen of the human body.

As shown in FIG. 11, the waist belt 5 is worn around the user's waist. The drive actuator 3 is located behind the waist. The fixing joints are set on both sides of the human body, and include a right fixing joint 61 and a left fixing joint 62.

The right fixing joint 61 is connected to the right wing of the waist belt 5, and the left fixing joint 62 is connected to the left wing of the waist belt 5. The first drive back end 41 is strapped to the user's right thigh, and the second drive back end 42 is strapped to the user's left thigh.

As shown in FIG. 8, the drive actuator 3 consists of a stator housing 31, a rotor shaft 32, a sleeve 33, and a right connecting shaft 34. The drive actuator 3 drives the rotor shaft 32 to rotate relative to the stator housing 31. There is an axial track between the sleeve 33 and the stator housing 31, the right connecting shaft 34 is connected to the first drive rod 1, and the rotor shaft 32 is connected to the second drive rod 2. The drive actuator 3 may use a rotary motor.

The second drive rod 2 and the first drive rod 1 are symmetrically designed.

The left fixing joint 62 is mounted on the hinge between the second rotating arm 21 and the second curved rod 22, and the left fixing joint 62 uses a spherical sliding bearing. The second drive back end 42 and the second curved rod 22 are connected through another spherical joint.

As shown in FIG. 12, the connecting block 40 provides a critical degree of freedom for the entire mechanism, allowing the entire mechanism to operate comfortably in cooperation with the human body. Because the fixing joints 6 on both sides often cannot precisely couple with the left and right hip joints when worn, the rotation of the left and right thighs and the rotation of the second drive rod 2 and the first drive rod 1 are not concentric during walking. Consequently, there is a sliding tendency of the first drive back end 41 at the back end of the first drive rod 1 and the second drive back end 42 at the back end of the second drive rod 2 relative to the locating positions on the thighs.

This sliding tendency is ultimately reflected as a pressing sensation on the user's left and right thighs from the first drive back end 41 and the second drive back end 42, thereby affecting the wearing comfort.

Therefore, the connecting block 40 is set between the drive rod and the drive back end, one side of the connecting block 40 is connected to the curved rod of the drive rod through a spherical linkage, and the other side of the connecting block 40 is slidably connected to the drive back end. Therefore, there is a certain space of relative motion between the drive back end and the thigh, thereby resolving the sliding tendency and pressing sensation, and enhancing the wearing comfort.

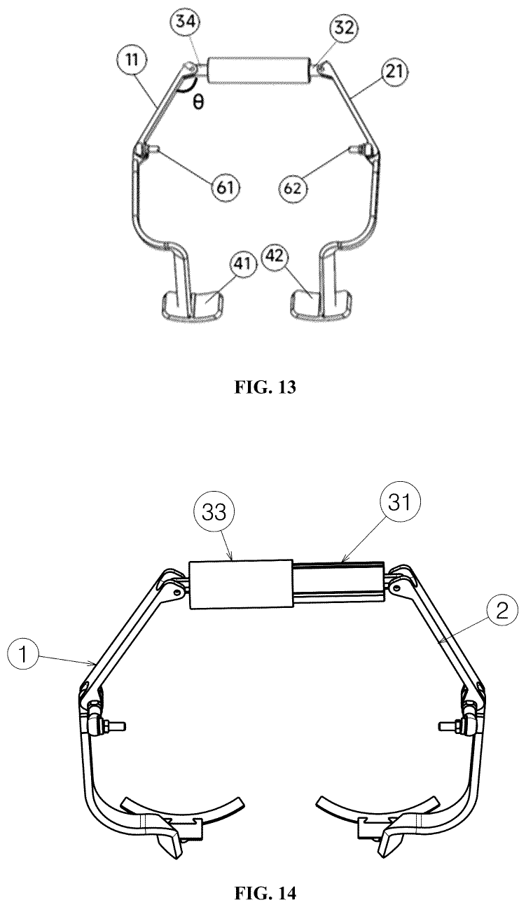

FIG. 13 is a diagram showing the adjustment of the waist size. The first drive rod 1 is connected to the sleeve 33 by a shaft, and the second drive rod 2 is connected to the rotor shaft 32 by a shaft. These two shafts may be loosened or tightened, such that the drive actuator 3 and the first and second drive rods set on two sides of the drive actuator 3 can be fixed at any angle. By increasing or decreasing the angle θ between the drive actuator 3 and each of the first drive rod and the second drive rod, a distance between the left and right fixing joints 61 can be increased or decreased. Thus, the device, in cooperation with the adjustable waist belt, is suitable for users with different waist sizes.

FIG. 14 shows another manner of adjusting the width between the first drive rod 1 and the second drive rod 2 to fit users of different body types. The stator housing 31 and the sleeve 33 can perform axial telescopic motion through a guide rail, and their relative positions can be fixed after the telescopic length is fixed, thereby increasing or decreasing the distance between the first drive rod 1 and the second drive rod 2.

FIG. 11 is a diagram showing the standing posture of the user when wearing the present disclosure.

The entire mechanism is connected to the left and right wings of the waist belt 5 through fixing joints 6 on both sides, and the waist belt 5 remains fixed and stationary with the user's waist.

At this time, the rotor shaft 32 and the stator housing 31 of the drive actuator 3 are in a balanced state, and both are at the same angle, with an angle difference of 0. In the standing posture, the user's left and right feet can both be on the ground; and the drive actuator 3 is located behind or in front of the user's waist, and is in a horizontal state relative to the ground.

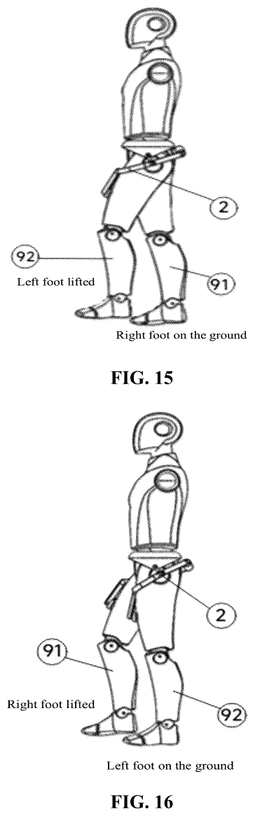

FIG. 15 is a diagram showing the posture of the user when the left foot is lifted while wearing the present disclosure. At this time, the rotor shaft 32 of the drive actuator 3 rotates forward relative to the stator housing 31. Correspondingly, the second drive rod 2 also rotates forward relative to the first drive rod 1.

In this posture, the user's right leg 91 is on the ground and remains stationary relative to the ground. Since the first drive rod 1 is strapped to the right leg 91, the first drive rod 1 is also stationary relative to the ground. In this state, the second drive rod 2 is lifted under the action of the counteracting force generated by the drive actuator 3, thereby driving the user's left leg 92 to be lifted.

FIG. 16 is a diagram showing the posture of the user when the right foot is lifted while wearing the present disclosure. At this time, the rotor shaft 32 of the drive actuator 3 rotates inversely relative to the stator housing 31. Correspondingly, the second drive rod 2 also rotates inversely relative to the first drive rod 1. In this posture, the user's left leg 92 is on the ground and remains stationary relative to the ground. Since the second drive rod 2 is strapped to the left leg 92, the second drive rod 2 is also stationary relative to the ground. In this state, the first drive rod 1 is lifted under the action of the counteracting force generated by the drive actuator 3, thereby driving the user's right leg 91 to be lifted.

In summary, by giving the drive actuator 3 alternating forward and reverse rotations, the left and right legs can alternately be lifted and grounded, thus enabling the user to walk.

In the present disclosure, the human body's intention to apply force can also be obtained through a force intention sensor, e.g., a force sensor. The mode of the force intention sensor is recognized through a central processor using a mathematical model and the human body's intention is converted into a drive signal for a motor. The drive signal is then transmitted to the thigh through a mechanical structure to provide assistance.

The present disclosure has advantages of low cost and stable structure. According to the assistance device, a single drive actuator is used to control the left and right legs, which reduces the cost, power consumption, and weight, and improves the overall assistance performance. Also, it is extremely convenient to control the device. Secondly, the left rotatable base 50 and the right rotatable base 60 are rigidly connected to the drive actuator 10, and the drive actuator 10 is suspended on one side of the human body. The assistance force generated by the left drive rod 51 and the right drive rod 61 rotating relative to the rotatable base is directly applied to both legs, such that both legs separate and merge, independent of the hips. Therefore, the hips only need to bear part of the weight of the assistance device, avoiding the situation where there is local effort-saving but overall effort-consuming.

The specific implementations are merely intended to describe the technical ides and structural features of the present disclosure, with the purposes of assisting those familiar with this technology in implementing the technology based on the present disclosure. However, the contents described above are not intended to limit the protection scope of the present disclosure, and any equivalent variations and modifications made based on the spirit of the present disclosure shall fall within the protection of the present disclosure.

1. A lightweight human body assistance device based on a single drive actuator, comprising: a rigid support, a drive actuator, a left drive mechanism, and a right drive mechanism; wherein
the left drive mechanism comprises a left rotatable base and a left drive rod that swings relative to the left rotatable base, and the left rotatable base is fixed on a left side of the rigid support;
the right drive mechanism comprises a right rotatable base and a right drive rod that swings relative to the right rotatable base, and the right rotatable base is fixed on a right side of the rigid support;
the drive actuator comprises a left transmission cable connected to the left drive rod, a right transmission cable connected to the right drive rod, an auxiliary transmission cable connecting the left drive rod and the right drive rod, and a drive mechanism that drives the left transmission cable and the right transmission cable; and
wherein the drive mechanism pulls the left transmission cable to drive the left drive rod to swing relative to the left rotatable base; and during swinging of the left drive rod, the auxiliary transmission cable drives the right drive rod to swing in an opposite direction to the left drive rod; and
the drive mechanism pulls the right transmission cable to drive the right drive rod to swing relative to the right rotatable base; and during swinging of the right drive rod, the auxiliary transmission cable drives the left drive rod to swing in an opposite direction to the right drive rod.

2. The lightweight human body assistance device based on a single drive actuator according to claim 1, wherein
the left transmission cable and the auxiliary transmission cable are arranged on two sides of a connection point of the left drive rod in a swing direction of the left drive rod; and
the right transmission cable and the auxiliary transmission cable are arranged on two sides of a connection point of the right drive rod in a swing direction of the right drive rod.

3. The lightweight human body assistance device based on a single drive actuator according to claim 1, wherein the drive mechanism comprises a ball screw, a sliding platform that moves reciprocally along the ball screw, and a driver that drives the ball screw to rotate; and
wherein a left side of the sliding platform is connected to the left transmission cable, and a right side of the sliding platform is connected to the right transmission cable.

4. The lightweight human body assistance device based on a single drive actuator according to claim 1, wherein the left rotatable base and the right rotatable base are fixed to hips by an elastic strap wrapped around the human body.

5. The lightweight human body assistance device based on a single drive actuator according to claim 4, wherein the left rotatable base and the right rotatable base are swingable relative to the elastic strap.

6. The lightweight human assistance body device based on a single drive actuator according to claim 5, wherein each of the left rotatable base and the right rotatable base is connected to the elastic strap through a swivel ball joint.

7. The lightweight human body assistance device based on a single drive actuator according to claim 1, wherein each of the left drive rod and the right drive rod is fixedly connected to a thigh by a flexible strap.

8. The lightweight human body assistance device based on a single drive actuator according to claim 1, wherein a torque output end of the drive actuator is connected to the left drive mechanism to transmit torque to the left drive mechanism, and a body of the drive actuator is fixed on the right drive mechanism to transmit a counteracting force received by the left drive mechanism when driving a left leg of the human body to the right drive mechanism and the counteracting force serves as power for the right drive mechanism to drive a right leg of the human body.

9. A lightweight human body assistance device based on a single actuator, comprising: a drive actuator, and a first drive rod and a second drive rod respectively set on two sides of the drive actuator; wherein,
the drive actuator comprises a stator housing and a rotor shaft rotatable relative to the stator housing;
the first drive rod rotates with the stator housing, and the second drive rod rotates with the rotor shaft;
one side of the first drive rod is connected to a first drive back end that matches a leg on one side of the human body, and one side of the second drive rod is connected to a second drive back end that matches a leg on other side of the human body; and
when the drive actuator is in operation, the stator housing and the rotor shaft rotate reciprocally within a certain angle such that the first drive rod and the second drive rod are driven to drive legs on both sides to move reciprocally relative to each other.

10. The lightweight human body assistance device according to claim 9, wherein
a front end of the first drive rod is connected to the stator housing, and a back end of the first drive rod is connected to the first drive back end that fits the leg on one side of the human body; and
a front end of the second drive rod is connected to the rotor shaft, and a back end the second drive rod is connected to the second drive back end that fits the leg on the other side of the human body.

11. The lightweight human body assistance device according to claim 10, wherein a fixing joint is connected to each of the first drive rod and the second drive rod, the fixing joint is connected to the human body and provides support and fixation for the drive actuator, the first drive rod and the second drive rod, and each of the first drive rod and the second drive rod rotates around a corresponding fixing joint.

12. The lightweight human body assistance device according to claim 11, wherein the fixing joint is fixed around a hip joint of the human body.

13. The lightweight human body assistance device according to claim 12, further comprising: a waist belt that matches the human body; wherein the fixing joint is fixed around the hip joint of the human body through the waist belt.

14. The lightweight human body assistance device according to claim 9, wherein the first drive rod comprises a first rotating arm and a first curved rod; and the second drive rod comprises a second rotating arm and a second curved rod;
a front end of the first rotating arm is connected to the stator housing, and a back end of the first curved rod is equipped with the first drive back end that is connected to and matches the leg on one side of the human body; and
a front end of the second rotating arm is connected to the rotor shaft, and a back end of the second curved rod is equipped with the second drive back end that is connected to and matches the leg on the other side of the human body.

15. The lightweight human body assistance device according to claim 14, wherein the first rotating arm and the first curved rod are hinged; and the second rotating arm and the second curved rod are hinged.

16. The lightweight human body assistance device according to claim 14, wherein
there is a certain range of relative displacement space between the first curved rod and the first drive back end; and
there is a certain range of relative displacement space between the second curved rod and the second drive back end.

17. The lightweight human body assistance device according to claim 16, wherein
a connecting block is arranged between the first curved rod and the first drive back end, the first curved rod is connected to one side of the connecting block through a spherical linkage, and the first drive back end is slidably connected to other side of the connecting block; and
a connecting block is arranged between the second curved rod and the second drive back end, the second curved rod is connected to one side of the connecting block through a spherical linkage, and the second drive back end is slidably connected to other side of the connecting block;
wherein the first drive back end and the second drive back end are arc-shaped plates that match the legs of the human body; and
wherein the arc-shaped plates are located in front of or behind the legs of the human body.

18. The lightweight human body assistance device according to claim 15, wherein the drive actuator is horizontally positioned at a back or front of waist and abdomen of the human body; and
wherein the first drive rod and the second drive rod are rigidly connected to the two sides of the drive actuator, respectively; and the drive actuator is suspended around the human body when in use.

19. The lightweight human body assistance device according to claim 12, wherein an angle between the first drive rod and the stator housing is adjustable, and an angle between the second drive rod and the rotor shaft is adjustable.

20. The lightweight human body assistance device according to claim 12, wherein the stator housing is set inside a sleeve, one side of the sleeve is provided with an opening that allows the stator housing to move reciprocally relative to the sleeve, and a depth of the stator housing in the sleeve is adjustable; and
the first drive rod is connected to the stator housing through the sleeve, and an angle between the first drive rod and the stator housing is adjustable.
